(19) United States
(12) Patent Application Publication
(10) Pub. No.: US 2012/0207017 A1
(43) Pub. Date: Aug. 16, 2012

(54) RECOVERY MECHANISM FOR POINT-TO-MULTIPOINT TRAFFIC

(76) Inventors: Daniele Ceccarelli, Genova (IT); Diego Caviglia, Savona (IT); Francesco Fondelli, Calcinaia (IT)

(21) Appl. No.: 13/384,054

(22) PCT Filed: Jul. 16, 2009
(86) PCT No.: PCT/EP09/59150

§ 371 Date: Apr. 27, 2012

(51) Int. Cl. H04L 12/437; H04L 12/26

(52) U.S. Cl. 370/227; 370/228

(57) ABSTRACT

A connection-oriented network (5) has a point-to-multipoint working path (10) between a source node (A) and a plurality of destination nodes (B-F). On detection of a failure in the working path, an indication of the failure is sent to a first node (e.g. node A) identifying the point of failure. The indication is sent via a control plane of the network. The first node selects one of a plurality of point-to-multipoint backup paths (21-25) based on the point of failure. Each backup paths connects the first node to the plurality of destination nodes. There is a point-to-multipoint backup path (21-25) for each of a plurality of possible points of failure along the working path. The backup paths (21-25) can be pre-configured to carry traffic in advance of the detection of failure. Alternatively, the first node can signal to nodes of the selected backup path to fully establish the backup path when it is required.

### TECHNICAL FIELD

This invention relates to a recovery mechanism for point-to-multipoint (P2MP) traffic paths in a connection-oriented network, such as a Generalised Multi-Protocol Label Switching (GMPLS), Multi-Protocol Label Switching (MPLS) or Multi-Protocol Label Switching Transport Profile (MPLS-TP) network.

### BACKGROUND

Multi-Protocol Label Switching Transport Profile (MPLS-TP) is a joint International Telecommunications Union (ITU-T)/Internet Engineering Task Force (IETF) effort to include an MPLS Transport Profile within the IETF MPLS architecture to support the capabilities and functionalities of a packet transport network as defined by ITU-T.

Many carriers have Synchronous Digital Hierarchy (SDH) networks. One goal of MPLS-TP is to allow a smooth migration from existing SDH networks to packet networks, thereby minimising the cost to carriers. Existing SDH networks are often based on a ring topology and it is desirable that MPLS-TP solutions work with this kind of network topology. Existing carrier networks have recovery mechanisms to detect and recover from a failure in the network and it is desirable that MPLS-TP networks also have resilience to failures. However, the recovery mechanism used in existing SDH networks cannot be directly applied to networks which use label switched paths.

RFC4872 describes signalling to support end-to-end GMPLS recovery, but the scope of this document is limited to point-to-point (P2P) paths.

WO 2008/080418A1 describes a protection scheme for an MPLS network having a ring topology. A primary path connects an ingress node to a plurality of egress nodes. A pre-configured secondary path also connects the ingress node to the plurality of egress nodes. In the event of a failure, traffic is sent along both the primary path and the secondary path, thus ensuring that each egress node receives traffic via the primary path or the secondary path.

An IETF Internet-Draft “P2MP traffic protection in MPLS-TP ring topology”, draft-ceccarelli-mpls-tp-p2 mp-ring-00, D. Ceccarelli et al, January 2009, describes a data plane-driven solution for the distribution and recovery of P2MP traffic over ring topology networks.

The present invention seeks to provide an alternative method of traffic recovery.

### SUMMARY

An aspect of the present invention provides a method of operating a first node in a connection-oriented network to provide traffic recovery according to claim 1.

The first node can select a backup path which is matched to the position of the failure, thereby efficiently re-routing traffic when a failure occurs. This minimises, or avoids, the need to send traffic over communication links in forward and reverse directions, as can often occur in the MPLS Fast Rerouting (FRR) technique which is implemented at the data plane level of the network. The use of a backup path which is used instead of the working path, and which connects to destination nodes of the working path, avoids a situation where a node receives the same packet of data via a working path and a backup path.

Advantageously, only one of the plurality of backup paths is used at a time. This allows the set of backup paths to share a common set of reserved resources, particularly in the case of a ring topology. The point-to-multipoint backup path makes efficient use of network resources compared to using a set of point-to-point (P2P) paths.

The first node can be the source node, or head node, of the point-to-multipoint working path. This is the most efficient arrangement as it minimises the number of communication links that are traversed in forward and reverse directions when traffic is sent along a backup path. However, in an alternative arrangement the first node can be positioned downstream of the source node along the working path.

Another aspect of the invention provides a method of traffic recovery in a connection-oriented network according to claim 11.

The methods can be applied to a range of different network topologies, such as meshed networks, but are particularly advantageous when applied to ring topologies.

Advantageously, the recovery scheme is used within a network having a Generalised Multi-Protocol Label Switching (GMPLS) or a Multi-Protocol Label Switching (MPLS) control plane. Data plane connections can be packet based or can use any of a range of other data plane technologies such as: wavelength division multiplexed traffic (lambda); or time-division multiplexed (TDM) traffic such as Synchronous Digital Hierarchy (SDH). The data plane can be an MPLS or an MPLS-TP data plane. The recovery scheme can also be applied to other connection-oriented technologies such as connection-oriented Ethernet or Provider Backbone Bridging Traffic Engineering (PBB-TE), IEEE 802.1Qay.

Further aspects of the invention provide apparatus for performing the methods.

The functionality described here can be implemented in software, hardware or a combination of these. The functionality can be implemented by means of hardware comprising several distinct elements and by means of a suitably programmed processing apparatus. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to the perform the required functions. Another aspect of the invention provides machine-readable instructions (software) which, when executed by a processor, perform any of the described methods. The machine-readable instructions may be stored on an electronic memory device, hard disk, optical disk or other machine-readable storage medium. The machine-readable instructions can be downloaded to a processing apparatus via a network connection.

### BRIEF DESCRIPTION OF THE DRAWINGS

Embodiments of the invention will be described, by way of example only, with reference to the (accompanying drawings in which:

FIG. 1 shows a network having a ring topology and a point-to-multipoint (P2MP) working path;

FIG. 2 shows a failure in the network and a P2MP backup path;

FIGS. 3A-3E show a set of backup paths for different points of failure in the network;

FIG. 4 shows a cross-connection function at a node of the network;

FIG. 5 shows apparatus at a node of the network;

FIG. 6 shows apparatus at a network management system;

FIG. 7 shows steps of a method of configuring recovery in a network;

FIG. 8 shows steps of a method of backup switching at a node;

FIGS. 9 to 11 show a network having a meshed topology and a point-to-multipoint (P2MP) working path;

FIGS. 12 and 13 show another example of a P2MP working path and a backup path for a network having a ring topology.

### DETAILED DESCRIPTION

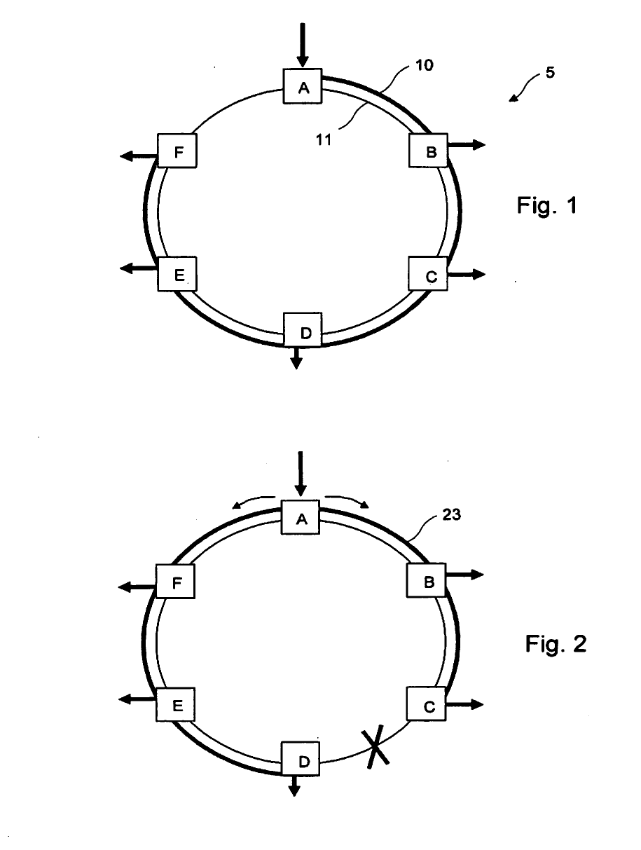

FIG. 1 shows a communications network 5 having a ring topology. Nodes A-F are connected by communication links 11, which can use optical, electrical, wireless or other technologies. Advantageously, the network supports Multi-Protocol Label Switching (MPLS) or Multi-Protocol Label Switching Transport Profile (MPLS-TP). These are connection-oriented technologies in which label switched paths (LSP) are established across a network. At each node A-F there is a Label Switching Router (LSR) which makes a forwarding decision for a transport unit by inspecting a label carried within the header of a received transport unit. It will be appreciated that the ring shown in FIG. 1 can form a part of an overall network having a more elaborate topology. The transport units can be packet or non-packetised digital signals.

FIG. 1 shows an example of a Point-to-multipoint (P2MP) label-switched path 10 between a source node A and destination nodes B, C, D, E, F. As is known, a label-switched path (LSP) is configured by a Management Plane or a Control Plane. To configure a LSP by the Management Plane, a Network Management System (NMS) instructs each node A-F along the path to implement a required forwarding behaviour. To configure a LSP by the Control Plane, the head node signals to other nodes along the intended path and each node configures the required forwarding behaviour to support the LSP. The P2MP path 10 delivers traffic from the ingress node A to each of the egress nodes B-F. The P2MP LSP may be uni-directional, and is particularly useful where there is a need to transmit the same data to multiple destinations, such as Internet Protocol Television (IPTV). The P2MP LSP can be bi-directional with, for example, the same P2MP path 10 also delivering traffic in the return direction from any of nodes B-F to node A.

Node A is called the head node of the ring and is the root node of the P2MP LSP 10. The communication links 11 of the path are monitored to detect a failure in a communications link or node. Failure detection can be performed using the Operations, Administration and Management (OAM) tools provided by MPLS-TP, or by any other suitable mechanism. One form of failure detection mechanism periodically exchanges a Continuity Check message between a pair of nodes. If a reply is not received within a predetermined time period, an alarm is raised.

Now consider that a failure affects the link between nodes C and D. This failure affects the P2MP LSP 10, as it prevents traffic from reaching nodes D, E, F. FIG. 2 shows a way of restoring a connection to the nodes served by the original LSP 10. A backup path LSP comprises a P2MP LSP 20 which connects ingress node A to the nodes B-F.

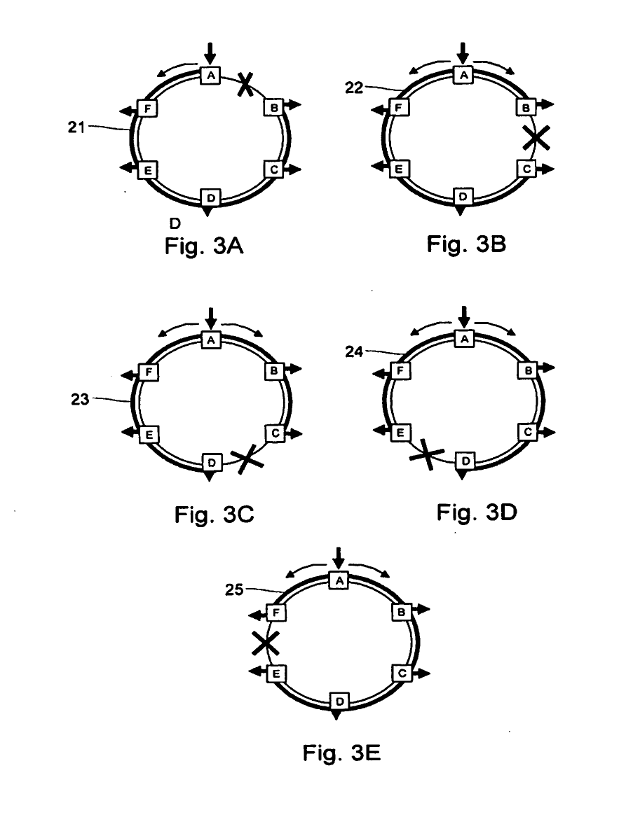

Node A is provided with a set of pre-computed and pre-signalled backup P2MP LSPs, one for each possible point of failure in the network. The extent to which the backup paths are configured is described below, and varies depending on whether “restoration” or “protection” is required. The full set of possible backup LSPs for the working path LSP of FIG. 1 is shown in FIGS. 3A-3E. Each backup LSP has a connectivity which is matched to a possible failure position in the network. FIG. 3A shows a backup LSP for a failure in the link A-B. The backup LSP extends in an anti-clockwise direction around the ring via nodes F, E, D, C and B. Nodes F, E, D and C are configured to drop and continue traffic and node B is configured to drop traffic. FIG. 3B shows a backup LSP for a failure in the link B-C, with a first branch extending clockwise around the ring to reach node B and a second branch extending anti-clockwise around the ring via nodes F, E, D and C. Generally, in a ring network comprising N nodes, N−1 backup LSPs are required. The backup LSP can be signalled, at the time of configuration, using an RSVP-TE Path message carrying a PROTECTION object.

In the event of a node or link failure a signalling message is sent from a node detecting the failure (in FIG. 2 the node detecting the failure will be node C) to the ingress node A in order to activate the recovery mechanism. Node A selects the backup LSP for the failure location on link C-D. This backup LSP is a P2MP LSP having node A as a root, nodes B, E and F dropping and continuing traffic and nodes C and D just dropping traffic.

The backup LSP can protect the ring from a link failure (e.g. link C-D) and a node failure (e.g. node D). Node failure may be detected using the same mechanisms used for link detection (e.g. OAM, RSVP-TE hello). In the event of node failure it is not possible to route traffic to, or through, the failed node.

The signalling message sent from the node that detects a failure can be a ReSource ReserVation Protocol-Traffic Engineering (RSVP-TE) Notify message. This message is sent via the Control Plane of the network.

There are two possible ways of operating: (i) restoration and (ii) protection.

### (i) Restoration Scheme

In the restoration scheme, resources required for the backup paths 21-25 are not cross-connected at the data plane level prior to a failure. This allows other LSPs to use the bandwidth of the backup paths until they are needed. This scheme requires some additional time, following failure detection, to signal to nodes along the backup path to cross-connect resources. The selected backup LSP is activated by cross-connecting resources at the data plane level at each node. Traffic is then switched from the working LSP 10 to the backup LSP 20 that has just been prepared for use. The backup LSP can be activated using a modified Path message with the S bit set to 0 in the PROTECTION object. At this point, the link and node resources must be allocated for this LSP that becomes a primary LSP (ready to carry normal traffic).

At the initial stage of setting up the backup paths (pre-failure), the backup LSP is signalled but no resources are committed at the data plane level. The resources are pre-reserved only at the control plane level only. Signalling is performed by indicating in the Path message (in the PROTECTION object) that the LSPs are of type “working” and “protecting”, respectively. To make the bandwidth pre-reserved for the backup (not activated) LSP available for extra-traffic, this bandwidth could be included in the advertised Unreserved Bandwidth at priority lower (means numerically higher) than the Holding Priority of the protecting LSP. In addition, the Max LSP Bandwidth field in the Interface Switching Capability Descriptor sub-TLV should reflect the fact that the bandwidth pre-reserved for the protecting LSP is available for extra traffic. LSPs for extra-traffic then can be established using the bandwidth pre-reserved for the protecting LSP by setting (in the Path message) the Setup Priority field of the SESSION_ATTRIBUTE object to X (where X is the Setup Priority of the protecting LSP), and the Holding Priority field to at least X+1. Also, if the resources pre-reserved for the protecting LSP are used by lower-priority LSPs, these LSPs should be pre-empted when the protecting LSP is activated.

### (ii) Protection Scheme

In the protection scheme resources required for the backup paths are cross-connected at the data plane level prior to a failure. This allows a quick switch to a required one of the backup paths but it incurs a penalty in terms of bandwidth, as the resources of the backup paths are reserved. The reserved resources of a backup path can be used to carry other traffic, such as “best efforts” traffic, until a time at which the reserved resources are required to carry traffic along the backup path.

In the case where the backup LSP has the same bandwidth as the working path LSP 10, the set of backup paths shown in FIGS. 3A-3E only require an amount of resources equal to that of the working path. For example, assume the working path LSP 10 has a bandwidth of X on the link A-B. The backup working path also has a bandwidth X. The different backup paths shown in FIGS. 3B-3E all use a link A-B of bandwidth X. Because only one of the backup paths shown in FIGS. 3B-3E is used at any time, only one reservation of bandwidth X needs to be made, i.e. the four paths shown in FIGS. 3B-3E do not require a reservation of 4×. In situations where both the working path and one or more of the backup paths have the same routing they can share the same resources because only the working path or one of the set of backup paths is used at any time. As an example, the link A-B in the working path 25 is also used in the backup paths shown in FIGS. 3B-3E. All of these paths can share the same resources.

When the working path has recovered from the failure which originally caused the protection switch traffic is returned to the working path LSP 10. Nodes detect that working path is up in the same way they detect the fails (e.g. OAM-CC, RSVP-TE hello). When a node detects the failure ends, it may notify the information to the ingress node using an RSVP-TE NOTIFY message.

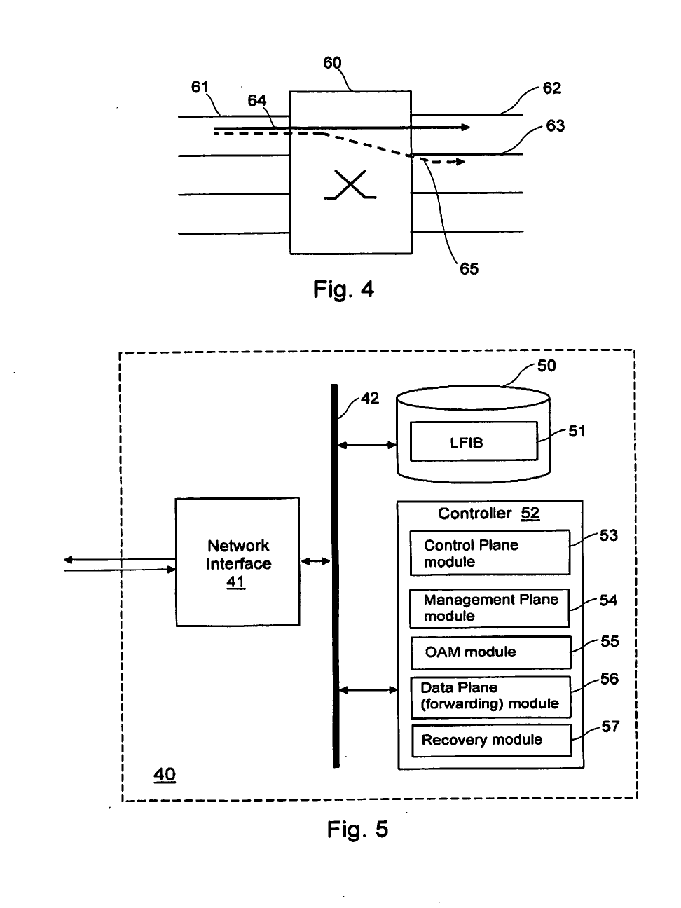

The operation of a node in the network will now be described in more detail. FIG. 4 schematically shows a cross-connect function 60 at one of the nodes. The node has ports 61, 62, 63 which connect to ingress or egress communication links. When the node is required to forward traffic to the next node the cross-connect function 60 will connect an ingress port 61 which receives traffic from a previous node on the ring to an egress port 62 which connects to the next node on the ring. The resulting cross-connection 64 is shown as a solid line connecting ports 61 and 62. When the node is required to forward traffic to a spur which leaves the ring, the cross-connect will connect an ingress port 61 which receives traffic from a previous node on the ring to an egress port 63 which connects to a spur leaving the ring. The resulting cross-connection 65 is shown as a dashed line connecting ports 61 and 63. A node may also perform forwarding along a reverse path.

FIG. 5 schematically shows a LSR 40 at a network node. The LSR 40 has a network interface 41 for receiving transport units (e.g. packets or frames of data) from other LSRs. Network interface 41 can also receive control plane signalling messages and management plane messages. A system bus 42 connects the network interface 41 to storage 50 and a controller 52. Storage 50 provides a temporary storage function for received packets before they are forwarded. Storage 50 also stores control data 51 which controls the forwarding behaviour of the LSR 40. In IETF terminology, the forwarding data 51 is called a Label Forwarding Information Base (LFIB).

Controller 52 comprises a set of functional modules 53-57 which control operation of the LSR. A Control Plane module 53 exchanges signalling and routing messages with other network nodes and can incorporate functions for IP routing and Label Distribution Protocol. The Control Plane module 53 can support RSVP-TE signalling, allowing the LSR 40 to signal to other nodes to implement the traffic recovery operation by signalling the occurrence of a failure and activating a required backup LSP. A Management Plane module 54 (if present) performs signalling with a Network Management System, allowing LSPs to be set up. An OAM module 55 supports OAM signalling, such as Continuity Check signalling, to detect the occurrence of a link or node failure. A Data Plane forwarding module 56 performs label look up and switching to support forwarding of received transport units (packets). The Data Plane forwarding module 56 uses the forwarding data stored in the LFIB 51. A combination of the Data Plane forwarding module 56 and LFIB 51 perform the cross-connect function shown in FIG. 4. A Recovery module 57 performs functions of selecting a suitable backup path and controlling the switching of traffic to the selected backup path. The set of modules can be implemented as blocks of machine-executable code, which are executed by a general purpose processor or by one or more dedicated processors or processing apparatus. The modules can be implemented as hardware, or a combination of hardware and software. Although the functionality of the apparatus are shown as set of separate modules, it will be appreciated that a smaller, or larger, set of modules can perform the functionality.

Although a single storage entity 50 is shown in FIG. 2, it will be appreciated that multiple storage entities can be provided for storing different types of data. Similarly, although a single controller 52 is shown, it will be appreciated that multiple controllers can be provided for performing the various control functions. For example, forwarding of packets can be performed by a dedicated high-performance processor while other functions can be performed by a separate processor.

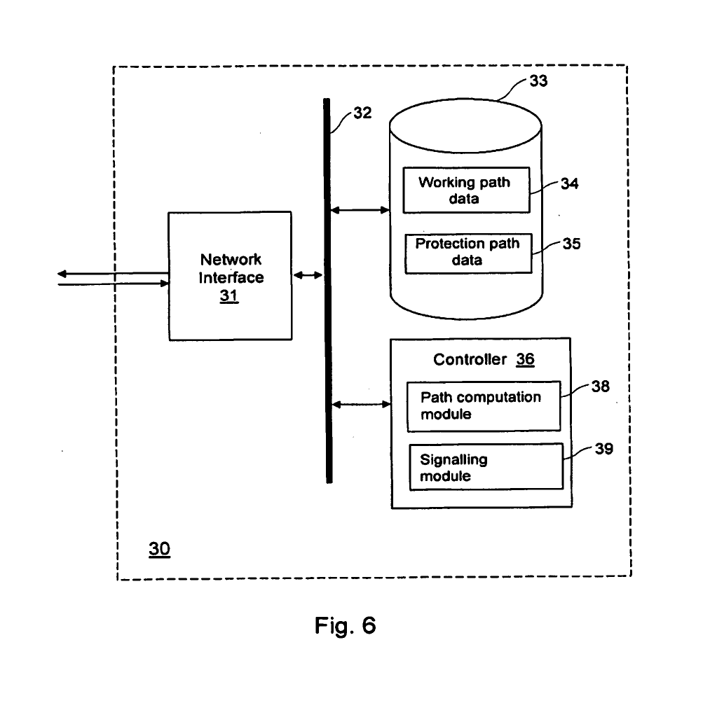

FIG. 6 schematically shows apparatus at a network management entity 30 which forms part of a management plane of the network. The entity 30 has a network interface 31 for sending and receiving signalling messages to nodes in the network. A system bus 32 connects the network interface 31 to storage 33 and a controller 36. Storage 33 stores control data 34, 35 for the network. Controller 36 comprises a path computation module 38 which computes a routing for the working path and backup paths. A signalling module 39 interacts with nodes to instruct them to store forwarding instructions to implement the working path and backup paths.

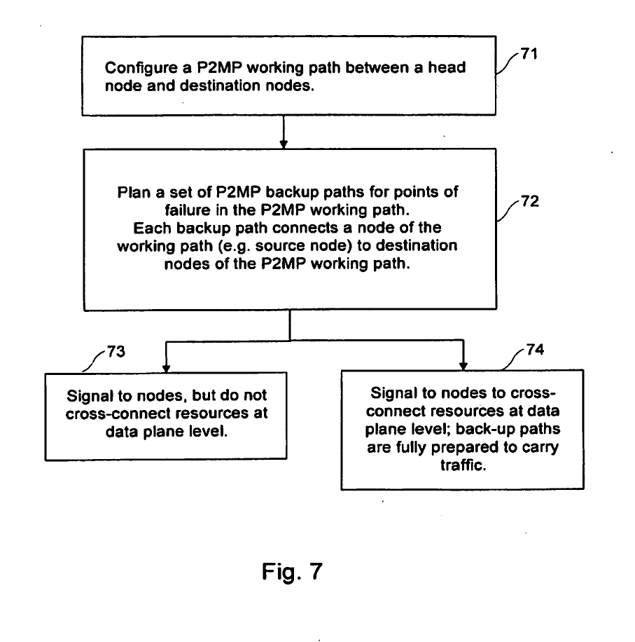

FIG. 7 summarises the steps of a method for configuring recovery in a network. At step 71a P2MP working path is established between a source node and destination nodes. At step 72 a set of P2MP backup paths are configured for possible points of failure in the network. Each P2MP backup path connects a node (e.g. head node) of a working path to destination nodes of the P2MP working path. The next step depends on whether a restoration scheme or a protection scheme is required.

For a restoration scheme, the method proceeds to step 73 and signals to nodes. The signalling may include instructing nodes to reserve suitable resources, such as bandwidth, to support the backup paths. However, nodes are not instructed to cross-connect resources at the data plane level. This means that the back-up path is not fully established, and requires further signalling at the time of failure detection to fully establish the backup path.

For a protection scheme, the method proceeds to step 74 and signals to nodes. The signalling instructs nodes to fully establish the backup paths in readiness for use. This includes reserving suitable resources, such as bandwidth, to support the backup paths. The nodes are also instructed to cross-connect resources at the data plane level. This means that the back-up path is fully established, and may not require any further signalling at the time of failure detection to carry traffic.

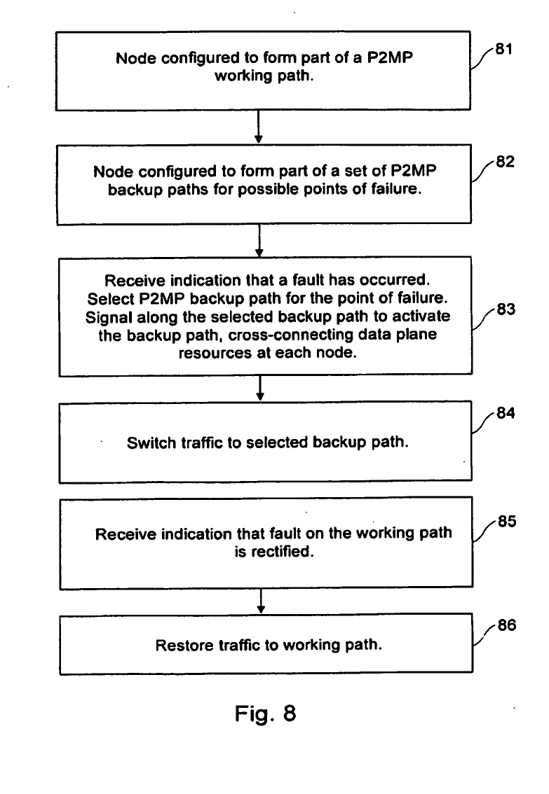

FIG. 8 summarises the steps, performed at a node of the network, for implementing a method of backup switching. Advantageously, the node is an ingress node or head node of the working path, but could also be a node downstream of the head node. At step 81 the node is configured to form part of a P2MP working path. At step 82 a set of P2MP backup paths are configured. Each backup path relates to a possible point of failure in the network. At step 83 the node receives an indication that a failure has occurred in the working path, and identifies the location of the failure (e.g. a link or node). The node then selects the backup path appropriate to the position of the failure that has just occurred, and signals to nodes along the backup path to set up the backup path. Advantageously, the node instructs nodes along the backup path to cross-connect resources at the data plane to support the required backup path. When the node receives an indication that the backup path is set up, traffic is switched to the backup path at step 84. At step 85, which occurs some time after step 84, the node receives an indication that the working path is functional. At step 86 the node restores traffic back to the working path.

The example P2MP working path LSP 10 shown in FIG. 1 has a head node at node A and a single branch extending in a clockwise direction around the ring via nodes B-F. It will be appreciated that the working path LSP 10 could have a different routing and the backup paths will each have a routing to provide a suitable backup path to support the routing of the working path LSP.

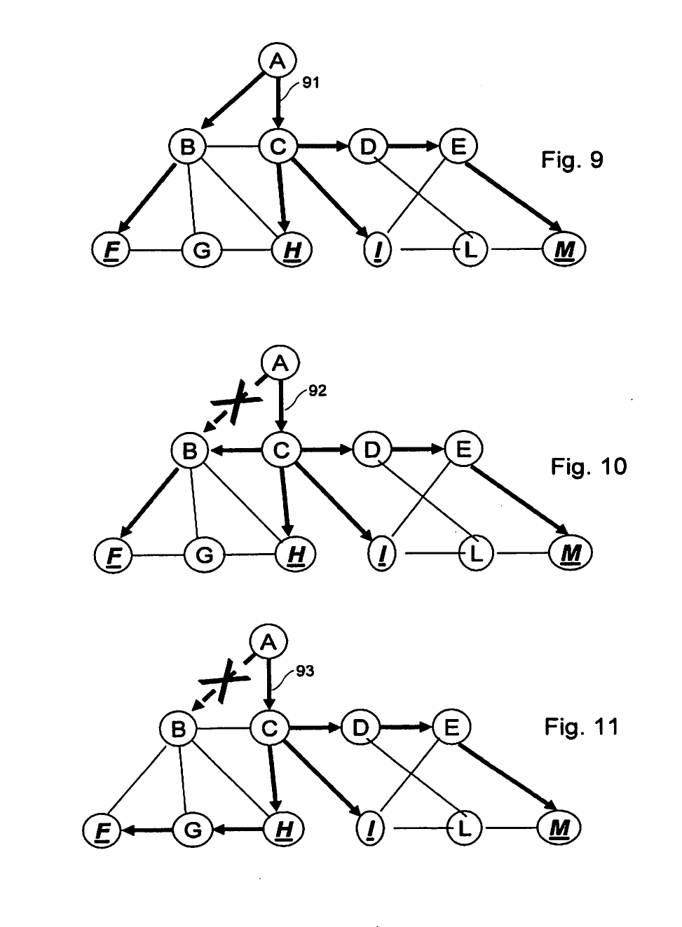

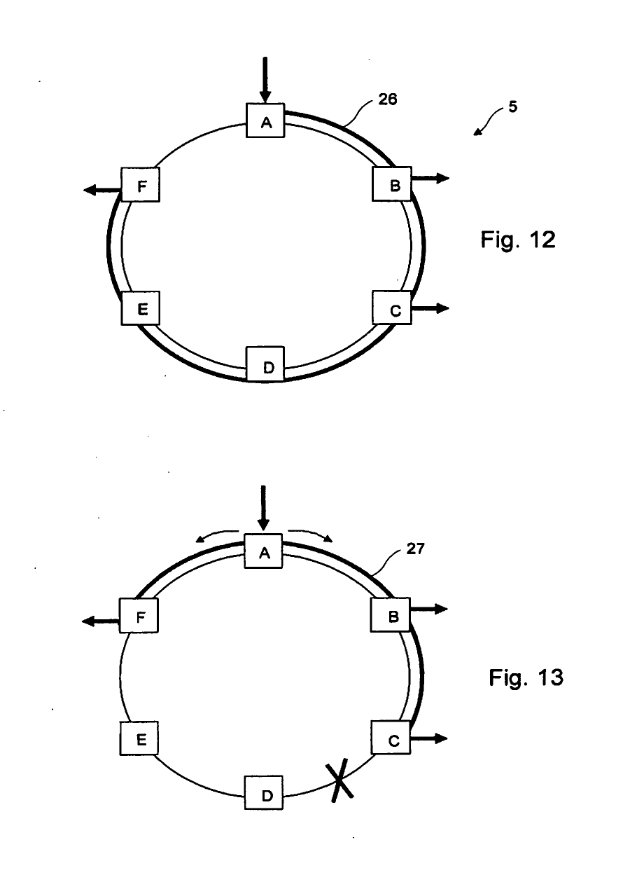

FIGS. 9 and 10 show an example of a P2MP working path 91 applied to a network having a meshed topology. The P2MP working path 91 has a root at node A and destination nodes F, H, I and M. As with the previous examples, a backup path is provided for each possible point of failure in the working path. Consider a failure on link A-B, as shown in FIG. 10. A possible backup LSP 92 for this point of failure is shown in FIG. 10. It provides a connection to destination node F via the path A-C-B-F. FIG. 11 shows another possible backup LSP 93 for this point of failure, which provides a connection to destination node F via the path A-C-H-G-F, with node H being another destination node of the working path. A backup path will be planned based on factors such as path length, path capacity and path cost.

The backup paths only need to connect to destination nodes of the working path, and nodes which must be transited to reach the destination nodes. In the example shown in FIGS. 1, 2 and 3A-3E, the working path connects node A to a set of nodes B-F which are all destination nodes, i.e. traffic must reach each of nodes B-F because it egresses the ring at those nodes. Therefore, the set of backup LSPs shown in FIGS. 3A-3E connect node A to each of nodes B-E. FIG. 12 shows the same ring topology of FIG. 1 and a working path 26 which has node A as a root node and only nodes B, C and F as destination nodes. The working path 26 passes via nodes D and E, but these are only “transit” nodes, as traffic is not destined for those nodes. FIG. 13 shows a backup path 27 when there is a failure in the link C-D. The backup path 27 only connects node A to nodes B, C and F. There is no need to connect to nodes D or E. Similarly, the meshed network example of FIGS. 9 to 11 also demonstrates how the backup path only connects to destination nodes of the working path and nodes which need to be transited in order to reach a destination node. In FIG. 13 the backup path 93 does not pass via node B because this is not a destination node of the working path.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

1. A method of operating a first node in a connection-oriented network to provide traffic recovery, where a point-to-multipoint working path is established between a source node and a plurality of destination nodes, the first node lying on the working path, the method comprising:
receiving, at the first node, an indication that a failure has occurred in the working path, the indication identifying the point of failure;
selecting one of a plurality of point-to-multipoint backup paths based on the point of failure, wherein the plurality of point-to-multipoint backup paths connect the first node to the plurality of destination nodes, there being a point-to-multipoint backup path for each of a plurality of possible points of failure along the working path; and
sending traffic along the selected point-to-multipoint backup path.

2. A method according to claim 1 wherein the indication is a signalling message received via a control plane of the network.

3. A method according to claim 2 wherein the signalling message is an RSVP-TE message.

4. A method according to any one of the preceding claims wherein the first node is the source node of the point-to-multipoint working path.

5. A method according to any one of the preceding claims wherein the step of selecting one of the plurality of point-to-multipoint backup paths comprises signalling to nodes along the selected backup path to cross-connect resources at a data plane level to implement the selected backup path.

6. A method according to any one of claims 1 to 4 wherein the plurality of point-to-multipoint backup paths are configured, prior to the step of receiving an indication that a failure has occurred, to a state in which they can forward traffic.

7. A method according to any one of the preceding claims wherein the connection-oriented network has a ring topology.

8. A method according to claim 7 wherein the working path is configured to travel in a first direction around the ring and the backup path comprises a branch which travels in an opposite direction around the ring.

9. A method according to any one of the preceding claims wherein the plurality of backup paths share a common set of resources.

10. A method according to any one of the preceding claims wherein the working path and backup path are Multi-Protocol Label Switching (MPLS) or Multi-Protocol Label Switching Transport Profile (MPLS-TP) connections.

11. A method of traffic recovery in a connection-oriented network, the method comprising:
configuring a point-to-multipoint working path between a source node and a plurality of destination nodes of the network,
planning, before detection of a failure, a plurality of point-to-multipoint backup paths between a first node on the working path and the plurality of destination nodes of the working path, there being a point-to-multipoint backup path for each of a plurality of possible points of failure along the working path.

12. A method according to claim 11 wherein the first node is the source node.

13. A method according to claim 11 or 12 wherein the point-to-multipoint backup paths only connect to destination nodes of the working path and nodes which must be transited to reach the destination nodes of the working path.

14. A method according to claim 11 or 12 wherein the step of planning comprises signalling to nodes, before detection of a failure, to configure the plurality of point-to-multipoint backup paths, the signalling instructing the nodes to cross-connect resources at a data plane level such that the configured paths are in a state in which they can forward traffic.

15. A method according to any one of claims 11 to 14 wherein the connection-oriented network has a ring topology.

16. A method according to claim 15 wherein the working path is configured to travel in a first direction around the ring and the backup path comprises a branch which travels in an opposite direction around the ring.

17. A method according to any one of claims 11 to 16 wherein the plurality of backup paths share a common set of resources.

18. A method according to any one of claims 11 to 17 wherein the working path and backup path are Multi-Protocol Label Switching (MPLS) or Multi-Protocol Label Switching Transport Profile (MPLS-TP) connections.

19. Apparatus for use at a first node of a connection-oriented network the apparatus comprising:
a first module which is arranged to receive instructions to configure the first node to form part of a point-to-multipoint working path between a source node and a plurality of destination nodes;
a second module which is arranged to receive instructions to configure the first node to form part of a point-to-multipoint backup path connecting the first node to destination nodes of the working path, wherein the plurality of point-to-multipoint backup paths connect the first node to the plurality of destination nodes, there being a point-to-multipoint backup path for each of a plurality of possible points of failure along the working path;
a third module which is arranged to receive an indication of a failure in the working path;
a fourth module which is arranged to select one of a plurality of point-to-multipoint backup paths based on the point of failure and to switch traffic to the selected point-to-multipoint backup path.

20. Apparatus according to claim 19 wherein the first node is the source node of the working path.

21. A control entity for a connection-oriented network comprising a plurality of nodes, the control entity being arranged to:
configure a point-to-multipoint working path between a source node and a plurality of destination nodes of the network,
plan, before detection of a failure, a plurality of point-to-multipoint backup paths between a first node on the working path and the plurality of destination nodes of the working path, there being a point-to-multipoint backup path for each of a plurality of possible points of failure along the working path.

22. Machine-readable instructions for causing a processor to perform the method according to any one of claims 1 to 18.
